(19) United States
(12) Patent Application Publication
(10) Pub. No.: US 2004/0177120 A1
(43) Pub. Date: Sep. 9, 2004

(54) Method for filtering e-mail messages

(76) Inventor: Steven T. Kirsch, Los Altos Hills, CA (US)

Correspondence Address: SCHNECK & SCHNECK, P.O. BOX 2-E, SAN JOSE, CA, 95109-0005, US

(21) Appl. No.: 10/384,278

(22) Filed: Mar. 7, 2003

(51) Int. Cl. G06F 15/16

(52) U.S. Cl. 709/206

(57) ABSTRACT

A method for filtering e-mail messages based on an identification of a true sender and assessing the reputation of the true sender among other users of an e-mail network. The true sender of a received e-mail message is identified in one embodiment by combining data in the e-mail message that is nearly impossible to forge with other information in the e-mail message. The reputation, or rating, of the true sender among other users in the e-mail network is then assessed by looking up the true sender in a database which maintains statistics, provided by the users in the network, on true senders. If the rating of a true sender exceeds some threshold set by the recipient, the message is passed on to the recipient. This method may work in combination with other e-mail filtering programs. An analogous method can be employed to detect e-mail messages having a computer virus sent via an attachment. The attachment is identified, for instance by computing a checksum value of the attachment or using the name of the attachment, and the reputation of the attachment, based on statistics sent by other e-mail users in the network, is assessed to determine whether the attachment contains a virus.

### FIELD OF THE INVENTION

This invention relates to data communications and, in particular, to processing e-mail messages.

### BACKGROUND OF THE INVENTION

The proliferation of junk e-mail, or “spam,” can be a major annoyance to e-mail users who are bombarded by unsolicited e-mails that clog up their mailboxes. While some e-mail solicitors do provide a link which allows the user to request not to receive e-mail messages from the solicitors again, many e-mail solicitors, or “spammers,” provide false addresses so that requests to opt out of receiving further e-mails have no effect as these requests are directed to addresses that either do no exist or belong to individuals or entities who have no connection to the spammer.

It is possible to filter e-mail messages using software that is associated with a user's e-mail program. In addition to message text, e-mail messages contain a header having routing information (including IP addresses), a sender's address, recipient's address, and a subject line. The information in the message header may be used to filter messages. One approach is to filter e-mails based on words that appear in the subject line of the message. For instance, an e-mail user could specify that all e-mail messages containing the word “mortgage” be deleted or posted to a file. An e-mail user can also request that all messages from a certain domain be deleted or placed in a separate folder, or that only messages from specified senders be sent to the user's mailbox. These approaches have limited success since spammers frequently use subject lines that do not indicate the subject matter of the message (subject lines such as “Hi” or “Your request for information” are common). In addition, spammers are capable of forging addresses, so limiting e-mails based solely on domains or e-mail addresses might not result in a decrease of junk mail and might filter out e-mails of actual interest to the user.

“Spam traps,” fabricated e-mail addresses that are placed on public websites, are another tool used to identify spammers. Many spammers “harvest” e-mail addresses by searching public websites for e-mail addresses, then send spam to these addresses. The senders of these messages are identified as spammers and messages from these senders are processed accordingly.

More sophisticated filtering options are also available. For instance, Mailshell™ SpamCatcher works with a user's e-mail program such as Microsoft Outlook™ to filter e-mails by applying rules to identify and “blacklist” (i.e., identifying certain senders or content, etc., as spam) spam by computing a spam probability score. The Mailshell™ SpamCatcher Network creates a digital fingerprint of each received e-mail and compares the fingerprint to other fingerprints of e-mails received throughout the network to determine whether the received e-mail is spam. Each user's rating of a particular e-mail or sender may be provided to the network, where the user's, ratings will be combined with other ratings from other network members to identify spam.

Mailfrontier™ Matador™ offers a plug-in that can be used with Microsoft Outlook™ to filter e-mail messages. Matador™ uses whitelists (which identify certain senders or content as being acceptable to the user), blacklists, scoring, community filters, and a challenge system (where an unrecognized sender of an e-mail message must reply to a message from the filtering software before the e-mail message is passed on to the recipient) to filter e-mails.

Spammers are still able to get past many filter systems. Legitimate e-mail addresses may be harvested from websites and spammers may pose as the owners of these e-mail addresses when sending messages. Spammers may also get e-mail users to send them their e-mail addresses (for instance, if e-mail users reference the “opt-out” link in unsolicited e-mail messages), which are then used by the spammers to send messages. In addition, many spammers forge their IP address in an attempt to conceal which domain they are using to send messages. One reason that spammers are able to get past many filter systems is that only one piece of information, such as the sender's e-mail address or IP address, is used to identify the sender; however, as noted above, this information can often be forged and therefore screening e-mails based on this information does not always identify spammers.

Computer viruses sent by e-mail, generally as attachments, have become increasingly problematic. Anti-virus software is available to detect and eliminate viruses but generally is only effective for identified viruses; in other words, new viruses may infect a computer running anti-virus software if it is received and activated at the computer before the software is updated about the new virus.

Therefore, there is a need for an effective approach to identifying filtering unwanted e-mails that is able to block e-mails from spammers using forged or appropriated identities. It would also be desirable to have a filter system that does not necessarily rely on a challenge system to allow e-mail from unrecognized senders to reach the recipient. There is also a need for an approach to identifying messages containing viruses without having to rely on anti-virus software that requires updates in order to identify new viruses.

### SUMMARY OF THE INVENTION

These needs have been met by an e-mail filtering method that identifies the “true sender” of an e-mail message based on data in the e-mail message that is almost impossible to forge and then assessing the reputation, or rating, of the true sender to determine whether to pass the e-mail message on to the recipient.

The true sender may be identified, in one embodiment, by combining the full or base e-mail address and the IP address of the network device used to hand off the message to the recipient's trusted infrastructure (i.e., the sender's SMTP server, which sends the e-mail to the recipient's mail server or a forwarding server used by the recipient); this IP address is used because it is almost impossible to forge. In other embodiments, different pieces of information can be combined.

In yet another embodiment, a digital signature in the e-mail message may be used to identify the true sender. Other embodiments may combine the digital signature with other data (the full or base e-mail address, the final IP address, the domain name associated with the final IP address) in the e-mail message.

Once the true sender has been identified, the reputation of the true sender is assessed in order to determine whether the e-mail should be passed to the recipient or disposed off according to the recipient's preferences for handling suspected junk e-mail. A central database tracks statistics about true senders which are supplied by any user of the e-mail network. These statistics include the number of users who have placed the true sender on a whitelist, the number of users who have placed the true sender on a blacklist, the number of e-mails the true sender has sent since any user in the e-mail network first received a message from the true sender, etc. Based on the information stored at the central database, the reputation of a true sender is evaluated to determine whether it is above a threshold set by the recipient. If the true sender's reputation does exceed the threshold, the message is passed to the recipient. Otherwise, the message is disposed of according to the recipient's preferences.

In one embodiment of the invention, the software embodying this method may be used in conjunction with e-mail software that allows users to establish their own whitelists and blacklists. The received e-mail message is first evaluated to see whether it meets any of the criteria on the users' whitelists and blacklists; if it does not, the true sender is identified and the true sender's reputation is assessed to determine how to classify the e-mail message.

A similar approach may be employed to detect computer viruses sent via e-mail attachments. Attachments are identified either by checksum value or the name of the attachment. Statistics about the attachment identifier are kept at the central database and supplied by users of the network. Sample statistics include: the number of unique senders of an attachment with the checksum/name of the attachment over some predetermined period of time; the average number of messages sent per sender over some period of time; etc. Once the attachment is identified, the reputation of the attachment is then assessed to determine whether the attachment is a virus.

### BRIEF DESCRIPTION OF THE DRAWINGS

FIG. 1 is a block diagram of the network environment in which one embodiment of the invention operates.

FIG. 2 is a flowchart showing how e-mail is filtered in accordance with the invention.

FIG. 3 is a flowchart showing how the final IP address is determined in accordance with the invention.

FIG. 4a is an e-mail message header.

FIG. 4b is an e-mail message header.

FIG. 5a shows an identification of the true sender in accordance with one embodiment of the invention.

FIG. 5b shows an identification of the true sender in accordance with one embodiment of the invention.

### DETAILED DESCRIPTION

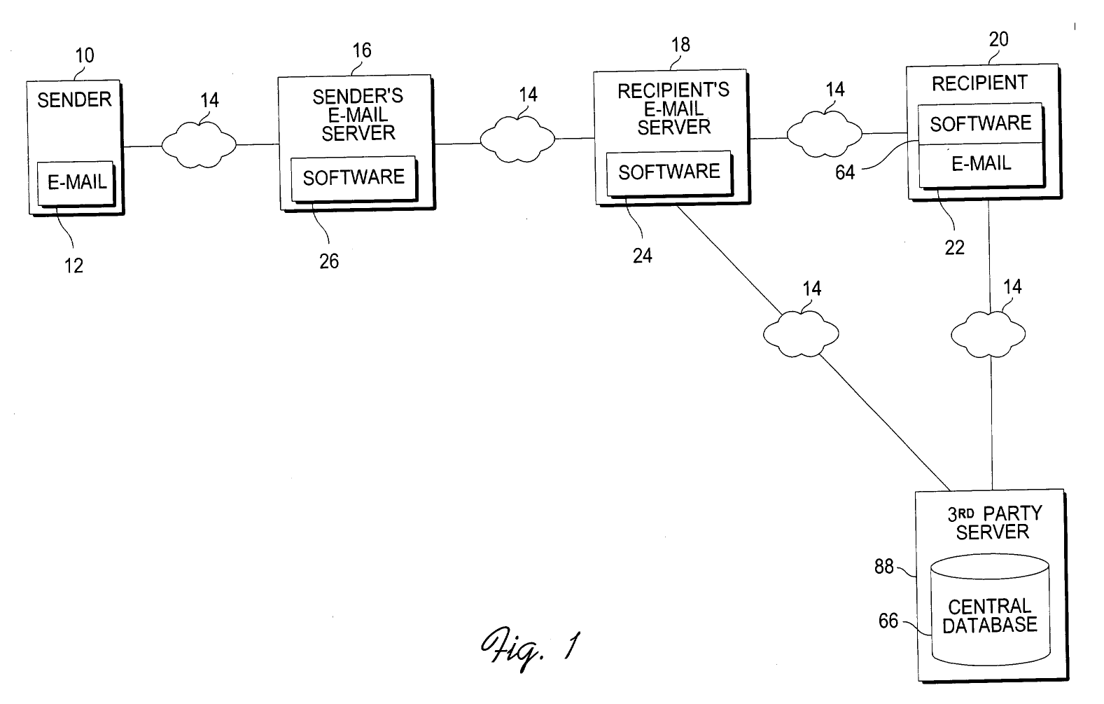

With reference to FIG. 1, one embodiment of the invention has a sender 10, for instance, a personal computer though the sender could be any computer device capable of sending messages in a network, which is running an e-mail software program 12, such as Outlook™, Eudora™, etc. The sender 10 is connected to the sender's e-mail server 16 via a network 14, such as the Internet. The sender's e-mail server 16 is running software 26 for handling the sender's e-mail messages. SMTP is generally used to send messages, while another protocol such as POP3 or IMAP is used for receiving messages; these protocols may run on different servers and the sender's 10 e-mail program 12 generally specifies both an SMTP server or a POP3 or IMAP server for handling messages. The sender's 10 e-mail messages are sent through a network 14 from the sender's e-mail server 16 to the recipient's e-mail server 18. The recipient's e-mail server 18 is running software 24 to handle incoming messages and relay them, via a network 14 connection, to the recipient's 20 e-mail program 22. Filtering software 64 is associated with the recipient's 20 e-mail program 22. In other embodiments, the filtering software may be located at the recipient's e-mail server 18 or at another device in the network. The recipient 20 is a member of an e-mail network consisting of other e-mail users employing the same approach to filtering e-mail messages.

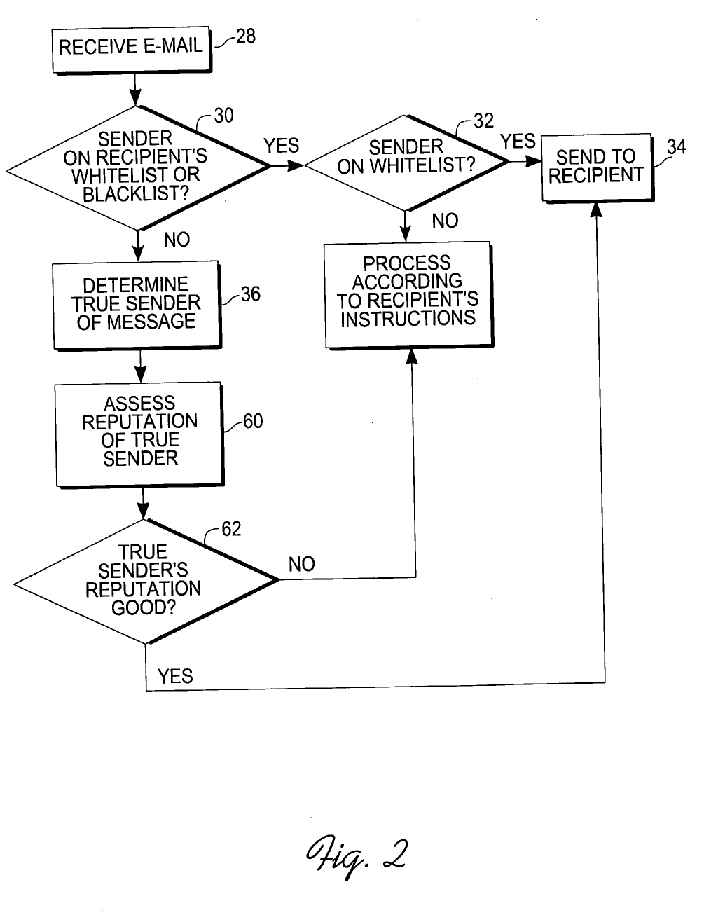

A central database 66 stores statistics about e-mail messages and “true senders” used to assess a true sender's reputation (discussed below in FIGS. 2, 3, 4a, and 4b) as well as members of the e-mail network. Software for managing the database and managing the e-mail network is associated with the database. In this embodiment, the database 66 is located at a third party LDAP server 88 which may be accessed over the network 14 by software 24, 64 at both the recipient's e-mail server 18 and the recipient 20. In other embodiments the central database 66 may be located elsewhere in the network 14, such as at the recipient's e-mail server 18 or in direct connection with the recipient's e-mail server 18. The central database 66 receives updates about e-mail messages and true senders sent at intervals by e-mail users, such as the recipient 20, within the e-mail network. Updates may be sent by the users (via the software 64 at their computers) either at regular, programmed intervals or at irregular intervals as determined by the user. In all embodiments, the database may be centrally located or a local copy may be used and updates synchronized with a central server on a regular bases. Since senders' reputations do not change rapidly over time, it is not strictly necessary to consult a central database on every e-mail.

In FIG. 2, the filtering process begins when an e-mail is received (in the embodiment shown above in FIG. 1, the e-mail is received at the recipient's computer) (block 28). In this embodiment of the invention, the e-mail is initially filtered by the recipient's personal “whitelists” (approved senders) and “blacklists” (unwanted senders) (block 30). These lists may be set up by the recipient using his or her e-mail software (such as Matador™ or Spamcatcher) and may filter messages based the sender, or words appearing in the subject header, etc. If the sender is on either the whitelist or blacklist (block 30), the message is processed as follows: if the sender is on the whitelist (block 32), the message is sent to the recipient (34); however, if the sender is on the blacklist (block 32), the message is processed according to the recipient's instructions for handling blacklisted messages, i.e., the message is deleted, placed in a separate folder, etc. (block 38). (In other embodiments, this initial filtering is not employed.)

If the sender is not on either the whitelist or the blacklist (block 30), the true sender of the e-mail is determined (see FIGS. 3, 4a, 4b, 5a, and 5b below for a full description) (block 36). Basically, the true sender is identified by combining pieces of data from the e-mail message, for instance, the full e-mail address of the sender and the domain name of the server which handed off the message to a network device trusted by the recipient, e.g., the recipient's mail server; at least one of the pieces of data used to identify the true sender is extremely difficult to forge and therefore the identity of the true sender is a valuable tool in determining whether an e-mail message has been manipulated by junk e-mail senders. (The full e-mail address includes both the name and e-mail address of the sender. If an e-mail address is “harvested” from a website by a spammer who forges his or her identity, the spammer is often unable to find the name of the owner of the e-mail and, therefore, if no full e-mail address is available, this is an indication the sender may be using a forged identity.)

The true sender's reputation is then assessed (block 60), for instance by checking a central database (for instance, at an LDAP server) which stores statistics about true senders which are provided by all users in an e-mail filtering network. Statistics stored and used to assess a true sender's reputation include: the number of e-mails the true sender has sent since any user in the filtering network first received a message from the true sender; the date an e-mail from the true sender was first seen; the number of users who have put the true sender on a whitelist; the number of users who have put the true sender on a blacklist; the number of e-mails sent to a spam trap (any senders sending e-mail to a spam trap can immediately be identified as a “bad” sender); the number of unique users in the network to whom the true sender has sent e-mail; the number of unique users in the network to whom the true sender has sent mail over a predetermined number of hours (this number may be set by the user, the system administrator, etc.); the number of e-mails the true sender has sent to users in the network over a predetermined number of hours which may be set by the user, system administrator, etc.; the number of unique users in the network to whom the true sender has sent e-mail over a predetermined number of hours (determined by user, system administrator, etc.) who previously have not received e-mail from the true sender; the number of e-mail messages sent by the true sender to users in the network over an interval of time (weeks, months, etc.) for a number of past intervals (for instance, how many e-mails were sent to users each month for a period of 3 months—the intervals and the number of past intervals surveyed may be determined by the user or the system administrator, etc.); the number of unique users in the network who have received e-mail messages from the true sender for each interval for a chosen (by the user or system administrator) number of past intervals; the date/time of the last e-mail sent; whether the true sender has been identified as a junk e-mailer or spammer in the past; the results of a proactive survey which asks a number of recipients of recent messages sent by the true sender to rate whether they consider the true sender to be a spammer; the number of e-mail messages sent by the true sender over a predetermined period of time (for instance, 3 hours—this period may be set by the user or the system administrator) which have bounced; whether the true sender's e-mail address accepts incoming e-mail messages; whether the true sender has ever responded to a challenge e-mail sent from within the e-mail network; whether any of information in the message header is forged; whether the domain name of the true sender matches the domain name of the final IP address (the IP address of the server which handed the mail message off to the recipient's trusted infrastructure—see FIG. 5, below); whether the content of the message matches the content of an e-mail caught by a spam trap (this match may be determined, for instance, by creating a unique hash code of the content of the known spam message and comparing it to a hash code based on the content of the received message); whether the true sender is a subscriber in good standing to the spam filtering service employed by the e-mail network; whether the true sender has ever registered on a special registration website (for instance, in response to a challenge sent to an e-mail sent by the true sender); the number of e-mails the true sender has received over a predetermined period of time (this period of time to be determined by the user or system administrator, etc.); the number of unique e-mail users in the network who have sent e-mail to the true sender; the number of unique e-mail users in the network who have regularly sent e-mail to the true sender; the number of unique recipients who have sent e-mail to the true sender; the number of unique users in the network who have sent e-mail messages to the true sender over a predetermined amount of time set by the user or system administrator; whether or not some rating entity (for instance, a subsystem or rating program within the network or another rating program or authority outside the network which sends information to the central database) considers the true sender to be a spammer; and the number of e-mail messages e-mail users in the network have sent to the true sender. Other statistics and metrics may also be stored and used to assess the sender's reputation. For each of the statistics listed above employing a predetermined amount of time, this amount of time is arbitrary and should be set according to the user's or system administrator's needs.

The process managing the database or a separate process external to the database may act on the data in the database to provide additional information to the database. For example, after the first two messages are seen from a new user, a process may choose to challenge the sender, check whether the sender's e-mail address accepts mail, or ask the recipient if they have ever heard of this user/sender. A wide variety of tests and actions are possible as information in the database changes as a result of both statistical input as well as the result of triggered actions resulting from database changes.

The database may have a default algorithm (which may be set by the system administrator) based on the collected data which indicates whether a true sender is a spammer or, depending on how the system in configured, may send the desired raw statistics to the user's e-mail program to that the user can use his or her own selection criteria to determine whether an e-mail is spam.

For instance, the recipient may set a threshold for determining whether a received e-mail is junk e-mail or may be of interest to the recipient. This threshold may be a ratio of other users' whitelist (#white) to blacklist (#black) rankings of a true sender. For example, if #white/(#white+#black) >0.5 (in other words, the true sender appeared on users' whitelists more often than the true sender appeared on blacklists), the e-mail message is passed through. Other considerations include the date an e-mail from a particular true sender was first encountered in the filtering network; if the date is less than a month, it is likely that the sender's address was generated by junk e-mailers. Similarly, if the filter network has only ever seen one e-mail message from a particular true sender, the sender's address may have been generated by junk e-mailers. The user or system administrator can set thresholds and considerations for determining the reputation of the true sender.

Referring again to FIG. 2, if the true sender's reputation is ultimately determined to be “good” (block 62, the message is sent to the recipient (block 34). However, if the true sender's reputation is not good (block 62), the e-mail message is processed according to the recipient's preferences for dealing with questionable e-mail (block 38).

As noted above, the identification of the “true sender” is useful in filtering and classifying e-mail messages because the identification includes information that is difficult or impossible to forge; therefore, identifying the true sender plays a large role in determining whether an e-mail message has been sent by an individual using a fake address. The true sender may be identified in a number of ways by combining information found in the e-mail message (generally, the message header).

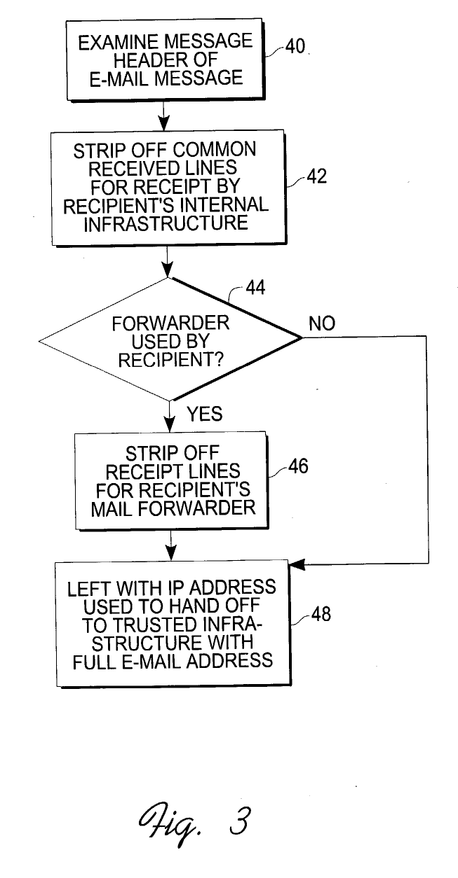

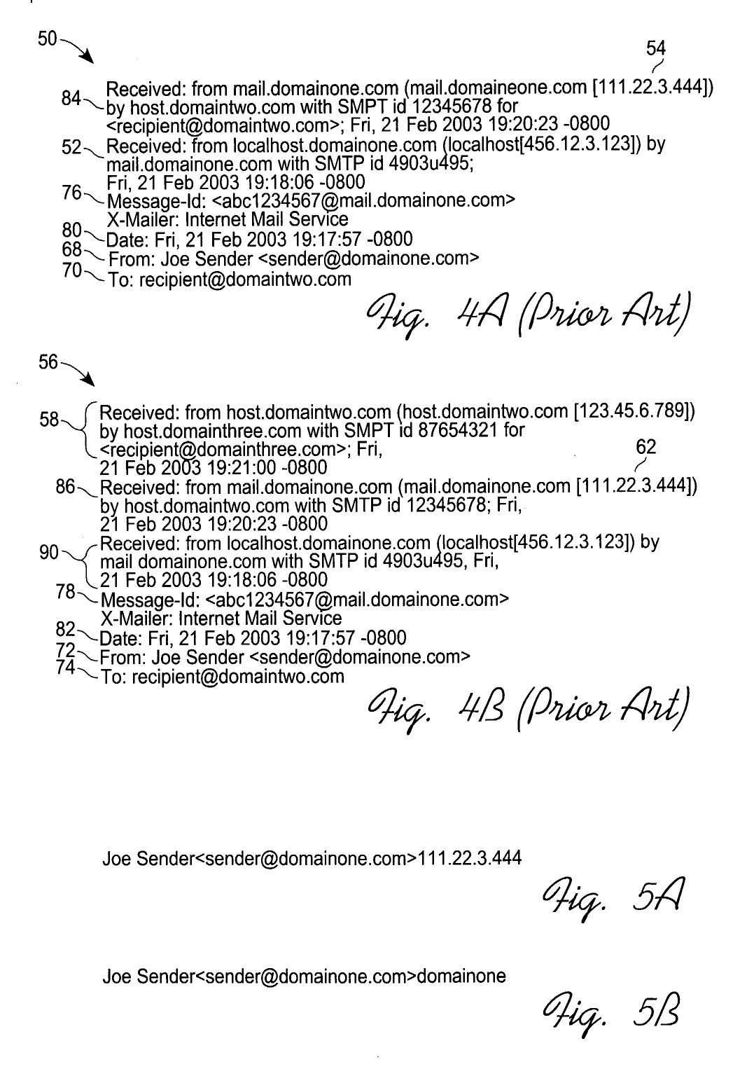

As shown in FIGS. 4a and 4b, message headers 50, 56 are known in the prior art. Message headers detail 50, 56 how an e-mail message arrived at the recipient's mailbox by listing the various relays 52, 84, 90, 86, 58 used to send the e-mail message to its destination. The sender 68, 72, recipient 70, 74, and date 80, 82 (when the message was written as determined by the sender's computer) are also listed. A unique Message-ID 76, 78 is created for each message.

Referring to FIG. 5a, one way to identify the true sender is to combine the full e-mail address (the sender's name along with the e-mail address, for example Joe Sender<sender@domainone.com>) with the “final IP address,” the IP address of the server which handed the e-mail message off to the recipient's trusted infrastructure (for instance, the recipient's mail server or a server associated with a recipient's forwarder or e-mail alias) The base e-mail address (sender@domainone.com) may also be combined with the final IP address in another embodiment.

In another embodiment, if the message contains some sort of digital signature associated with the sender, that signature may be used in conjunction with the e-mail address to determine the true sender. In yet another embodiment, if the message contains some sort of digital signature associated with the sender, that signature may be used to identify the true sender. In other embodiments, the digital signature may be combined with other information in the e-mail message, such as the final IP address, the domain name associated with the final IP address, or the full or base e-mail address, to identify the true sender.

Referring to FIG. 3, the final IP address may be determined by examining the message header of an e-mail message (block 40). Starting at the top of the message header, the common “received” lines indicating receipt by the recipient's internal infrastructure are stripped off (block 42). If no forwarder is used by the recipient (block 44), the remaining IP address corresponds to the server which handed off the message to the recipient's trusted infrastructure (block 48). If a forwarder is used (block 44), the receipt lines for the recipient's mail forwarder (i.e., the receipt lines indicating receipt after the message was received at the domain specified in the “to” section of the header) are stripped off (block 46). The remaining IP address is the final IP address (block 48).

Simplified schematics for identifying the final IP address from the message header are as follows. Where no forwarder is used, the message header identifies devices local to the recipient, i.e., the recipient's e-mail infrastructure, and devices that are remote to the recipient, presumably the sender's e-mail infrastructure. Therefore, if the message header identifies the various devices as follows:

local

local

local

remote←this is the final IP address

remote

remote

remote

Then the final IP address is the last remote server identified before the message is received by a local server. If a forwarding service is used, the message header might appear as follows:

local

local

local

forwarder

forwarder

remote←this is the final IP address

remote

remote

The final IP address in this situation is the last remote server identified before the message is received by the forwarding server.

In FIG. 4a, no forwarder is used. The final IP address 54 indicates the server, mail.domainone.com, that handed off to the recipient's server, domaintwo.com. With respect to FIG. 4b, a forwarder is used. Here, the receipt line 58 associated with the forwarder has to be stripped away to indicate the final IP address 62.

With respect to FIG. 5b, another way to identify the true sender is to combine the full e-mail address with the domain name of the server which handed the e-mail message off to the recipient's trusted infrastructure; the domain name of the server may be determined via a reverse DNS lookup of the IP address. In one embodiment, the identification of the true sender can be encoded into a unique hash code; this hash code subsequently could be used to look up the reputation of the true sender at the central database, which indexes information by the hash code of each true sender. In other embodiments, the identification of the true sender is not encoded.

Users may also be rated. For instance, if a user constantly rates a true sender known to send junk e-mail as “good,” that user's rating may be set to zero so his or her ratings are not considered by other users.

In one embodiment, the filtering system employed within the network will only allow authorized e-mail users to send e-mail into the system. An e-mail user becomes authorized if members of the filtering system regularly (more than once) send messages to that user. (The filter system members must be in “good standing”—in other words, no other members have complained they are spammers.) If e-mails between members and the authorized user go both ways and the total number of e-mails coming sent to members of the network from the authorized user is about equal to or less than the total number of e-mails sent by members to the authorized user, the authorized user is probably not a spammer. The advantage of this approach is that it depends only on measurements of incoming and outgoing e-mails of members of the network; it does not require measurement of the e-mails of the authorized e-mail user. That means the authorized user may or may not be a member of the network. (Depending on the configuration of the member's filter, the member initially may have to retrieve initial e-mails from the authorized user; however, the system should begin to recognize the external user as an approved sender fairly quickly.)In another embodiment, legitimate bulk e-mailers who send the network members far more e-mail messages then are sent to the bulk e-mailer may be recognized as approved senders by randomly surveying recipients of these e-mail messages. This survey may be conducted once or every few months. Legitimate bulk e-mailers may be identified by the following parameters: 1) they send to a lot of people; 2) they send a lot of e-mail; and 3) they send regularly (i.e., for at least a month) from the same address.

Penalties may be applied to both network members and spammers. If a sender sends to a spam trap, this sender can be invalidated and marked as a spammer for a period of time, for example, ninety days. If more than one member in good standing complains about a sender previously approved by another member, the member who gave his or her approval to the spammer has his or her approval ability stripped for a period of time, for instance, a month, and the spammer's statistics are reduced to “unknown” so that the spammer has to rebuild his or her reputation. A greater penalty may be imposed depending on how many complaints are received. In other embodiments, other penalties may be imposed.

In another embodiment, computer viruses may be detected using an analogous approach. However, instead of identifying and keeping statistics about the true sender, attachments are identified, for instance by computing a checksum value of the attachment or using the name of the attachment, and statistics about the attachment identifier are kept at the central database. These statistics may be sent to a database by other users in the e-mail network or may be obtained in some other fashion, for instance by network software which tracks activity within the network. Sample statistics used to assess the reputation of the attachment include: the number of unique senders of an attachment with a particular checksum/name of the attachment over a predetermined amount of time (for instance, the last 3 hours—this period of time may be set by the user or the system administrator); the average number of messages sent per sender over a predetermined amount of time (again set by the user or system administrator); the rate of growth of the number of messages with a particular checksum/name of the attachment; and the rate of growth of the number of unique senders sending messages with the particular checksum/name of the attachment. Other statistics and metrics may also be stored and used to determine whether a message is a virus. If these statistics are high enough (as determined by a user or system administrator), the message can be marked as a virus and dealt with according to the user's preferences.

For each of the statistics listed above employing a predetermined amount of time, this amount of time is arbitrary and should be set according to the user's or system administrator's needs.

What is claimed is:

1. A method of processing a received e-mail message comprising:
a) identifying a true sender of the received e-mail message based on at least two data items in the message;
b) assessing a reputation of the true sender within a network of e-mail users; and
c) filtering the e-mail message based on the reputation of the true sender.

2. The method of claim 1 further comprising initially filtering the e-mail message using at least one recipient-created list of recognized senders and processing the message according to the recipient's preferences if the sender of the message appears on at least one list of recognized senders.

3. The method of claim 1 wherein the reputation of the true sender is assessed by querying a database maintaining statistics about senders, the statistics obtained from the recipient and a plurality of other e-mail users in the network.

4. The method of claim 3 wherein the statistics include at least one of the following:
i) a number of e-mails the true sender has sent to users in the network;
ii) a date of the first e-mail sent by the true sender to a user in the network;
iii) a number of users in the network who have approved of receiving messages from the true sender;
iv) a number of users in the network who disapprove of receiving messages from the true sender;
v) a number of e-mail messages sent by the true sender to a spam trap;
vi) a number of unique users in the network to whom the true sender has sent messages;
vii) a number of unique users in the network to whom the true sender has sent at least one message over a first predetermined amount of time;
viii) a number of e-mail messages sent to users in the network over a second predetermined amount of time;
ix) a number of unique users in the network to whom the true sender has sent an e-mail message over a third predetermined amount of time, the users not having previously received a message from the true sender;
x) a number of e-mail messages sent by the true sender to users in the network for each determined interval of time over a course of a predetermined number of past time intervals;
xi) a number of unique users in the network to whom the true sender has sent messages over the course of the predetermined number of past intervals;
xii) a date of the last e-mail sent by the true sender;
xiii) a time of the last e-mail sent by the true sender;
xiv) an indication of whether the true sender previously has been determined to send junk e-mail;
xv) results of a proactive survey of a predetermined number of recent recipients of a message from the true sender, the survey asking the recipients to determine whether the true sender sent junk e-mail;
xvi) a number of e-mail addresses within the network to which the true sender has sent a message over a fourth predetermined amount of time where the sent message was bounced;
xvii) an indication of whether the true sender's e-mail address accepts incoming e-mail;
xviii) an indication of whether the true sender has ever responded to a challenge e-mail;
xix) an indication of whether a component of the true sender's e-mail message headers has been forged;
xx) an indication of whether the domain name of the true sender matches the domain name of the final IP address;
xxi) an indication of whether the content of a received message matches the content of an e-mail message caught in a spam trap;
xxii) an indication of whether the true sender is a subscriber in good standing to the e-mail filtering service;
xxiii) an indication of whether the true sender has ever registered on a special registration website;
xxiv) a number of unique users in the network who have sent e-mail messages to the true sender over a fifth predetermined amount of time;
xxv) a number of unique users in the network who have sent e-mail messages to the true sender;
xxvi) an indication of whether a rating entity considers the true sender to be a spammer;
xxvii) an indication of whether the rating entity does not consider the true sender to be a spammer;
xxviii) a number of e-mail messages users in the network have sent to the true sender; and
xxix) a number of unique users in the network who regularly send e-mail messages to the true sender.

5. The method of claim 3 further comprising a plurality of e-mail users in the network sending information about received e-mail messages to the database maintaining statistics about e-mail messages received within the network.

6. The method of claim 3 further comprising rating other users in the network so that the users' reputations are considered when using the users' statistics about the true sender to assess the reputation of the true sender.

7. The method of claim 1 further comprising filtering the e-mail message according to the reputation of the true sender based on a recipient's preferences for handling e-mail messages.

8. The method of claim 7 wherein filtering the e-mail message includes sending it to the recipient.

9. The method of claim 7 wherein filtering the e-mail message includes deleting the e-mail message.

10. The method of claim 7 wherein filtering the e-mail message includes sending the e-mail message to a specific location.

11. The method of claim 1 wherein the true sender is identified by combining a full e-mail address or a base e-mail address of a sender and an IP address of a first network device used to send the e-mail message to a second network device trusted by a recipient of the message.

12. The method of claim 1 wherein the true sender is identified by combining a full e-mail address or a base e-mail address of a sender and a domain name corresponding to an IP address of a first network device used to send the e-mail message to a second network device trusted by a recipient of the message.

13. The method of claim 1 wherein the true sender is identified by combining a digital signature in the e-mail message with one of the following:
a) an IP address of a first network device used to send the e-mail message to a second network device trusted by a recipient of the message;
b) a full e-mail address of a sender;
c) a base e-mail address of the sender; and
d) a domain name associated with the first network device used to send the e-mail message to the second network device trusted by the recipient of the message.

14. The method of claim 1 further comprising encoding an identity of the true sender.

15. The method of claim 14 further comprising storing the encoded identity of the true sender in a database.

16. The method of claim 15 further comprising using the encoded identity of the true sender to assess the reputation of the true sender.

17. The method of claim 3 further comprising sending information to the database maintaining statistics about e-mail messages received within the network from a spam trap.

18. A computer-readable storage medium storing instructions that, when executed by a computer, cause the computer to perform a method of processing a received e-mail message, the method comprising:
a) identifying a true sender of the received e-mail message based on at least two data items in the e-mail message;
b) assessing a reputation of the true sender within a network of e-mail users; and
c) filtering the e-mail message based on the reputation of the true sender.

19. The computer-readable storage medium of claim 18, the method further comprising initially filtering the e-mail message using at least one recipient-created list of recognized senders and processing the message according to the recipient's preferences if the sender of the message appears on at least one list of recognized senders.

20. The computer-readable storage medium of claim 18 wherein the reputation of the true sender is assessed by querying a database maintaining statistics about senders, the statistics obtained from the recipient and a plurality of other e-mail users in the network.

21. The computer-readable storage medium of claim 19 wherein the statistics include at least one of the following:
i) a number of e-mails the true sender has sent to users in the network;
ii) a date of the first e-mail sent by the true sender to a user in the network;
iii) a number of users in the network who have approved of receiving messages from the true sender;
iv) a number of users in the network who disapprove of receiving messages from the true sender; and
v) a number of e-mail messages sent by the true sender to a spam trap;
vi) a number of unique users in the network to whom the true sender has sent messages;
vii) a number of unique users in the network to whom the true sender has sent at least one message over a first predetermined amount of time;
viii) a number of e-mail messages sent to users in the network over a second predetermined amount of time;
ix) a number of unique users in the network to whom the true sender has sent an e-mail message over a third predetermined amount of time, the users not having previously received a message from the true sender;
x) a number of e-mail messages sent by the true sender to users in the network for each determined interval of time over a course of a predetermined number of past time intervals;
xi) a number of unique users in the network to whom the true sender has sent messages over the course of the predetermined number of past intervals;
xii) a date of the last e-mail sent by the true sender;
xiii) a time of the last e-mail sent by the true sender;
xiv) an indication of whether the true sender previously has been determined to send junk e-mail;
xv) results of a proactive survey of a predetermined number of recent recipients of a message from the true sender, the survey asking the recipients to determine whether the true sender sent junk e-mail;
xvi) a number of e-mail addresses within the network to which the true sender has sent a message over a fourth predetermined amount of time where the sent message was bounced;
xvii) an indication of whether the true sender's e-mail address accepts incoming e-mail;
xviii) an indication of whether the true sender has ever responded to a challenge e-mail;
xix) an indication of whether a component of the true sender's e-mail message headers has been forged;
xx) an indication of whether the domain name of the true sender matches the domain name of the final IP address;
xxi) an indication of whether the content of a received message matches the content of an e-mail message caught in a spam trap;
xxii) an indication of whether the true sender is a subscriber in good standing to the e-mail filtering service;
xxiii) an indication of whether the true sender has ever registered on a special registration website;
xxiv) a number of unique users in the network who have sent e-mail messages to the true sender over a fifth predetermined amount of time;
xxv) a number of unique users in the network who have sent e-mail messages to the true sender;
xxvi) an indication of whether a rating entity considers the true sender to be a spammer;
xxvii) an indication of whether the rating entity does not consider the true sender to be a spammer;
xxviii) a number of e-mail messages users in the network have sent to the true sender; and
xxix) a number of unique users in the network who regularly send e-mail messages to the true sender.

22. The computer-readable storage medium of claim 20, the method further comprising a plurality of e-mail users in the network sending information about received e-mail messages to the database maintaining statistics about e-mail messages received within the network.

23. The computer-readable storage medium of claim 20, the method further comprising rating other users in the network so that the users' reputations are considered when using the users' statistics about the true sender to assess the reputation of the true sender.

24. The computer-readable storage medium of claim 18, the method further comprising filtering the e-mail message according to the reputation of the true sender based on a recipient's preferences for handling e-mail messages.

25. The computer-readable storage medium of claim 24 wherein filtering the e-mail message includes sending it to the recipient.

26. The computer-readable storage medium of claim 24 wherein filtering the e-mail message includes deleting the e-mail message.

27. The computer-readable storage medium of claim 24 wherein filtering the e-mail message includes sending the e-mail message to a specific location.

28. The computer-readable storage medium of claim 18 wherein the true sender is identified by combining a full e-mail address or a base e-mail address of a sender and an IP address of a first network device used to send the e-mail message to a second network device trusted by a recipient of the message.

29. The computer-readable storage medium of claim 18 wherein the true sender is identified by combining a full e-mail address or a base e-mail address of a sender and a domain name corresponding to an IP address of a first network device used to send the e-mail message to a second network device trusted by a recipient of the message.

30. The computer-readable storage medium of claim 18 wherein the true sender is identified by combining a digital signature in the e-mail message with one of the following:
a) an IP address of a first network device used to send the e-mail message to a second network device trusted by a recipient of the message;
b) a full e-mail address of a sender; and
c) a base e-mail address of the sender; and
d) a domain name associated with the first network device used to send the e-mail message to the second network device trusted by the recipient of the message.

31. The computer-readable storage medium of claim 18, the method further comprising encoding an identification of the true sender.

32. The computer-readable storage medium of claim 31, the method further comprising storing the encoded identification of the true sender in a database.

33. The computer-readable storage medium of claim 32, the method further comprising using the encoded identification of the true sender to assess the reputation of the true sender.

34. The computer-readable storage medium of claim 20, the method further comprising sending information to the database maintaining statistics about e-mail messages received within the network from a spam trap.

35. A method of processing a received e-mail message comprising:
a) filtering the e-mail message using at least one recipient-created list of recognized senders; and
b) disposing of the message according to a recipient's preferences if the sender appears on the at least one recipient-created list, otherwise identifying a true sender of the message based on at least two data items in the e-mail message and filtering the message according to a reputation of the true sender within a network of other e-mail users.

36. The method of claim 35 further comprising assessing the reputation of the true sender within the network of other e-mail users.

37. The method of claim 35 wherein the reputation of the true sender is assessed by querying a database maintaining statistics about senders, the statistics obtained from the recipient and a plurality of other e-mail users in the network.

38. The method of claim 37 wherein the statistics including at least one of the following:
i) a number of e-mails the true sender has sent to users in the network;
ii) a date of the first e-mail sent by the true sender to a user in the network;
iii) a number of users in the network who have approved of receiving messages from the true sender;
iv) a number of users in the network who disapprove of receiving messages from the true sender; and
v) a number of e-mail messages sent by the true sender to a spam trap;
vi) a number of unique users in the network to whom the true sender has sent messages;
vii) a number of unique users in the network to whom the true sender has sent at least one message over a first predetermined amount of time;
viii) a number of e-mail messages sent to users in the network over a second predetermined amount of time;
ix) a number of unique users in the network to whom the true sender has sent an e-mail message over a third predetermined amount of time, the users not having previously received a message from the true sender;
x) a number of e-mail messages sent by the true sender to users in the network for each determined interval of time over a course of a predetermined number of past time intervals;
xi) a number of unique users in the network to whom the true sender has sent messages over the course of the predetermined number of past intervals;
xii) a date of the last e-mail sent by the true sender;
xiii) a time of the last e-mail sent by the true sender;
xiv) an indication of whether the true sender previously has been determined to send junk e-mail;
xv) results of a proactive survey of a predetermined number of recent recipients of a message from the true sender, the survey asking the recipients to determine whether the true sender sent junk e-mail;
xvi) a number of e-mail addresses within the network to which the true sender has sent a message over a fourth predetermined amount of time where the sent message was bounced;
xvii) an indication of whether the true sender's e-mail address accepts incoming e-mail;
xviii) an indication of whether the true sender has ever responded to a challenge e-mail;
xix) an indication of whether a component of the true sender's e-mail message header has been forged;
xx) an indication of whether the domain name of the true sender matches the domain name of the final IP address;
xxi) an indication of whether the content of a received message matches the content of an e-mail message caught in a spam trap;
xxii) an indication of whether the true sender is a subscriber in good standing to the e-mail filtering service;
xxiii) an indication of whether the true sender has ever registered on a special registration website;
xxiv) a number of unique users in the network who have sent e-mail messages to the true sender over a fifth predetermined amount of time;
xxv) a number of unique users in the network who have sent e-mail messages to the true sender;
xxvi) an indication of whether a rating entity considers the true sender to be a spammer;
xxvii) an indication of whether the rating entity does not consider the true sender to be a spammer;
xxviii) a number of e-mail messages users in the network have sent to the true sender.

39. The method of claim 37 further comprising a plurality of e-mail users in the network sending information about received e-mail messages to the database maintaining statistics about e-mail messages received within the network.

40. The method of claim 37 further comprising rating other users in the network so that the users' reputations are considered when using the users' statistics about the true sender to assess the reputation of the true sender.

41. The method of claim 35 further comprising filtering the e-mail message according to the reputation of the true sender based on the recipient's preferences for handling e-mail messages.

42. The method of claim 41 wherein filtering the e-mail message includes sending it to the recipient.

43. The method of claim 41 wherein filtering the e-mail message includes deleting the e-mail message.

44. The method of claim 41 wherein filtering the e-mail message includes sending the e-mail message to a specific location.

45. The method of claim 35 wherein the true sender is identified by combining a full e-mail address or a base e-mail address of a sender and an IP address of a first network device used to send the e-mail message to a second network device trusted by the recipient of the message.

46. The method of claim 35 wherein the true sender is identified by combining a full e-mail address or base e-mail address of a sender and a domain name corresponding to an IP address of a first network device used to send the e-mail message to a second network device trusted by a recipient of the message.

47. The method of claim 35 wherein the true sender is identified by combining a digital signature in the e-mail message with one of the following:
a) an IP address of a first network device used to send the e-mail message to a second network device trusted by a recipient of the message;
b) a full e-mail address of a sender; and
c) a base e-mail address of the sender; and
d) a domain name associated with the first network device used to send the e-mail message to the second network device trusted by the recipient of the message.

48. The method of claim 35 further comprising encoding an identification of the true sender.

49. The method of claim 48 further comprising storing the encoded identification of the true sender in the database.

50. The method of claim 49 further comprising using the encoded identification of the true sender to assess the reputation of the true sender.

51. The method of claim 37 further comprising sending information to the database maintaining statistics about e-mail messages received within the network from a spam trap.

52. A method of processing a received e-mail message comprising:
a) identifying a true sender of the received e-mail message based on at least a digital signature in the message;
b) assessing a reputation of the true sender within a network of e-mail users; and
c) filtering the e-mail message based on the reputation of the true sender.

53. The method of claim 52 further comprising initially filtering the e-mail message using at least one recipient-created list of recognized senders and processing the message according to the recipient's preferences if the sender of the message appears on at least one list of recognized senders.

54. The method of claim 52 wherein the reputation of the true sender is assessed by querying a database maintaining statistics about senders, the statistics obtained from the recipient and a plurality of other e-mail users in the network.

55. The method of claim 54 wherein the statistics include at least one of the following:
i) a number of e-mails the true sender has sent to users in the network;
ii) a date of the first e-mail sent by the true sender to a user in the network;
iii) a number of users in the network who have approved of receiving messages from the true sender;
iv) a number of users in the network who disapprove of receiving messages from the true sender;
v) a number of e-mail messages sent by the true sender to a spam trap;
vi) a number of unique users in the network to whom the true sender has sent messages;
vii) a number of unique users in the network to whom the true sender has sent at least one message over a first predetermined amount of time;
viii) a number of e-mail messages sent to users in the network over a second predetermined amount of time;
ix) a number of unique users in the network to whom the true sender has sent an e-mail message over a third predetermined amount of time, the users not having previously received a message from the true sender;
x) a number of e-mail messages sent by the true sender to users in the network for each determined interval of time over a course of a predetermined number of past time intervals;
xi) a number of unique users in the network to whom the true sender has sent messages over the course of the predetermined number of past intervals;
xii) a date of the last e-mail sent by the true sender;
xiii) a time of the last e-mail sent by the true sender;
xiv) an indication of whether the true sender previously has been determined to send junk e-mail;
xv) results of a proactive survey of a predetermined number of recent recipients of a message from the true sender, the survey asking the recipients to determine whether the true sender sent junk e-mail;
xvi) a number of e-mail addresses within the network to which the true sender has sent a message over a fourth predetermined amount of time where the sent message was bounced;
xvii) an indication of whether the true sender's e-mail address accepts incoming e-mail;
xviii) an indication of whether the true sender has ever responded to a challenge e-mail;
xix) an indication of whether a component of the true sender's e-mail message headers has been forged;
xx) an indication of whether the domain name of the true sender matches the domain name of the final IP address;
xxi) an indication of whether the content of a received message matches the content of an e-mail message caught in a spam trap;
xxii) an indication of whether the true sender is a subscriber in good standing to the e-mail filtering service;
xxiii) an indication of whether the true sender has ever registered on a special registration website;
xxiv) a number of unique users in the network who have sent e-mail messages to the true sender over a fifth predetermined amount of time;
xxv) a number of unique users in the network who have sent e-mail messages to the true sender;
xxvi) an indication of whether a rating entity considers the true sender to be a spammer;
xxvii) an indication of whether the rating entity does not consider the true sender to be a spammer;
xxviii) a number of e-mail messages users in the network have sent to the true sender; and
xxix) a number of unique users in the network who regularly send e-mail messages to the true sender.

56. The method of claim 54 further comprising a plurality of e-mail users in the network sending information about received e-mail messages to the database maintaining statistics about e-mail messages received within the network.

57. The method of claim 54 further comprising rating other users in the network so that the users' reputations are considered when using the users' statistics about the true sender to assess the reputation of the true sender.

58. The method of claim 52 further comprising filtering the e-mail message according to the reputation of the true sender based on a recipient's preferences for handling e-mail messages.

59. The method of claim 58 wherein filtering the e-mail message includes sending it to the recipient.

60. The method of claim 58 wherein filtering the e-mail message includes deleting the e-mail message.

61. The method of claim 58 wherein filtering the e-mail message includes sending the e-mail message to a specific location.

62. The method of claim 52 wherein the true sender is identified by combining a digital signature in the e-mail message with one of the following:
a) an IP address of a first network device used to send the e-mail message to a second network device trusted by a recipient of the message;
b) a full e-mail address of a sender;
c) a base e-mail address of the sender; and
d) a domain name associated with the IP address of the first network device used to send the e-mail message to the second network device trusted by the recipient of the message.

63. The method of claim 52 further comprising encoding an identity of the true sender.

64. The method of claim 63 further comprising storing the encoded identity of the true sender in a database.

65. The method of claim 64 further comprising using the encoded identity of the true sender to assess the reputation of the true sender.

66. The method of claim 54 further comprising sending information to the database maintaining statistics about e-mail messages received within the network from a spam trap.

67. A computer-readable storage medium storing instructions that, when executed by a computer, cause the computer to perform a method of processing a received e-mail message, the method comprising:
a) identifying a true sender of the received e-mail message based on at least a digital signature in the message;
b) assessing a reputation of the true sender within a network of e-mail users; and
c) filtering the e-mail message based on the reputation of the true sender.

68. The computer-readable storage medium of claim 67, the method further comprising initially filtering the e-mail message using at least one recipient-created list of recognized senders and processing the message according to the recipient's preferences if the sender of the message appears on at least one list of recognized senders.

69. The computer-readable storage medium of claim 67 wherein the reputation of the true sender is assessed by querying a database maintaining statistics about senders, the statistics obtained from the recipient and a plurality of other e-mail users in the network.

70. The computer-readable storage medium of claim 69 wherein the statistics include at least one of the following:
i) a number of e-mails the true sender has sent to users in the network;
ii) a date of the first e-mail sent by the true sender to a user in the network;
iii) a number of users in the network who have approved of receiving messages from the true sender;
iv) a number of users in the network who disapprove of receiving messages from the true sender; and
v) a number of e-mail messages sent by the true sender to a spam trap;
vi) a number of unique users in the network to whom the true sender has sent messages;
vii) a number of unique users in the network to whom the true sender has sent at least one message over a first predetermined amount of time;
viii) a number of e-mail messages sent to users in the network over a second predetermined amount of time;
ix) a number of unique users in the network to whom the true sender has sent an e-mail message over a third predetermined amount of time, the users not having previously received a message from the true sender;
x) a number of e-mail messages sent by the true sender to users in the network for each determined interval of time over a course of a predetermined number of past time intervals;
xi) a number of unique users in the network to whom the true sender has sent messages over the course of the predetermined number of past intervals;
xii) a date of the last e-mail sent by the true sender;
xiii) a time of the last e-mail sent by the true sender;
xiv) an indication of whether the true sender previously has been determined to send junk e-mail;
xv) results of a proactive survey of a predetermined number of recent recipients of a message from the true sender, the survey asking the recipients to determine whether the true sender sent junk e-mail;
xvi) a number of e-mail addresses within the network to which the true sender has sent a message over a fourth predetermined amount of time where the sent message was bounced;
xvii) an indication of whether the true sender's e-mail address accepts incoming e-mail;
xviii) an indication of whether the true sender has ever responded to a challenge e-mail;
xix) an indication of whether a component of the true sender's e-mail message headers has been forged;
xx) an indication of whether the domain name of the true sender matches the domain name of the final IP address;
xxi) an indication of whether the content of a received message matches the content of an e-mail message caught in a spam trap;
xxii) an indication of whether the true sender is a subscriber in good standing to the e-mail filtering service;
xxiii) an indication of whether the true sender has ever registered on a special registration website;
xxiv) a number of unique users in the network who have sent e-mail messages to the true sender over a fifth predetermined amount of time;
xxv) a number of unique users in the network who have sent e-mail messages to the true sender;
xxvi) an indication of whether a rating entity considers the true sender to be a spammer;
xxvii) an indication of whether the rating entity does not consider the true sender to be a spammer;
xxviii) a number of e-mail messages users in the network have sent to the true sender; and
xxix) a number of unique users in the network who regularly send e-mail messages to the true sender.

71. The computer-readable storage medium of claim 69, the method further comprising a plurality of e-mail users in the network sending information about received e-mail messages to the database maintaining statistics about e-mail messages received within the network.

72. The computer-readable storage medium of claim 69, the method further comprising rating other users in the network so that the users' reputations are considered when using the users' statistics about the true sender to assess the reputation of the true sender.

73. The computer-readable storage medium of claim 67, the method further comprising filtering the e-mail message according to the reputation of the true sender based on a recipient's preferences for handling e-mail messages.

74. The computer-readable storage medium of claim 73 wherein filtering the e-mail message includes sending it to the recipient.

75. The computer-readable storage medium of claim 73 wherein filtering the e-mail message includes deleting the e-mail message.

76. The computer-readable storage medium of claim 66, the method further comprising identifying the true sender by combining a digital signature in the e-mail message with one of the following:
a) an IP address of a first network device used to send the e-mail message to a second network device trusted by a recipient of the message;
b) a full e-mail address of a sender;
c) a base e-mail address of the sender; and
d) a domain name corresponding to the IP address of a first network device used to send the e-mail message to a second network device trusted by the recipient of the message.

77. The computer-readable storage medium of claim 67, the method further comprising encoding an identification of the true sender.

78. The computer-readable storage medium of claim 77, the method further comprising storing the encoded identification of the true sender in a database.

79. The computer-readable storage medium of claim 78, the method further comprising using the encoded identity of the true sender to assess the reputation of the true sender.

80. The computer-readable storage medium of claim 67, the method further comprising sending information to the database maintaining statistics about e-mail messages received within the network from a spam trap.

81. A method of processing a received e-mail message having an attachment comprising:
a) identifying an attachment of the received e-mail message;
b) assessing a reputation of the identified attachment within a network of e-mail users; and
c) filtering the e-mail message-based on the reputation of the identified attachment.

82. The method of claim 81 wherein the reputation of the identified attachment is assessed by querying a database maintaining statistics about attachments and senders, the statistics obtained from the recipient and a plurality of other e-mail users in the network.

83. The method of claim 82 wherein the statistics include at least one of the following:
a) a number of unique senders of a message with an attachment having a particular checksum value over a first predetermined period of time;
b) a number of unique senders of a message with an attachment having a particular name over a second predetermined period of time;
c) an average number of messages per sender over a third predetermined period of time;
d) a rate of growth of a number of messages in the network with an attachment having a particular checksum value;
e) a rate of growth of a number of messages in the network with an attachment having a particular name;
f) a rate of growth of a number of unique senders sending messages having an attachment with a particular checksum value; and
g) a rate of growth of a number of unique senders sending messages having an attachment with a particular name.

84. The method of claim 81 further comprising filtering the e-mail message based on a recipient's preferences for handling e-mail messages.

85. The method of claim 84 wherein filtering the e-mail message includes deleting the e-mail message.

86. The method of claim 81 wherein identifying the attachment includes calculating a checksum value of the attachment.

87. The method of claim 81 wherein identifying the attachment includes using a name of the attachment.

88. A computer-readable storage medium storing instructions that, when executed by a computer, cause the computer to perform a method of processing a received e-mail message having an attachment, the method comprising:
a) identifying an attachment of the received e-mail message;
b) assessing a reputation of the identified attachment within a network of e-mail users; and
c) filtering the e-mail message based on the reputation of the identified attachment.

89. The computer-readable storage medium of claim 88 wherein the reputation of the identified attachment is assessed by querying a database maintaining statistics about attachments and senders, the statistics obtained from the recipient and a plurality of other e-mail users in the network.

90. The computer-readable storage medium of claim 89 wherein the statistics include at least one of the following:
a) a number of unique senders of a message with an attachment having a particular checksum value over a first predetermined period of time;
b) a number of unique'senders of a message with an attachment having a particular name over a second predetermined period of time;
c) an average number of messages sent per sender over a third predetermined period of time;
d) a rate of growth of a number of messages in the network with an attachment having a particular checksum value;
e) a rate of growth of a number of messages in the network with an attachment having a particular name;
f) a rate of growth of a number of unique senders sending messages having an attachment with a particular checksum value; and
g) a rate of growth of a number of unique senders sending messages having an attachment with a particular name.

91. The computer-readable storage medium of claim 89, the method further comprising filtering the e-mail message based on a recipient's preferences for handling e-mail messages.

92. The computer-readable storage medium of claim 91 wherein filtering the e-mail message includes deleting the e-mail message.

93. The computer-readable storage medium of claim 88 wherein identifying the attachment includes calculating a checksum value of the attachment.

94. The computer-readable storage medium of claim 88 wherein identifying the attachment includes using a name of the attachment.
